(19) United States
(12) Patent Application Publication
(10) Pub. No.: US 2016/0212504 A1
(43) Pub. Date: Jul. 21, 2016

(54) Video Surveillance Method, Surveillance Server, and Surveillance System

(71) Applicant: Huawei Technologies Co., Ltd., Shenzhen (CN)

(72) Inventors: Yuetao Meng, Shenzhen (CN); Qiang Yan, Hangzhou (CN)

(21) Appl. No.: 15/082,525

(22) Filed: Mar. 28, 2016

Related U.S. Application Data
(63) Continuation of application No. PCT/CN2014/077343, filed on May 13, 2014.

(30) Foreign Application Priority Data
Sep. 27, 2013 (CN) 201310450190.2

(51) Int. Cl. H04N 21/8545; H04N 21/845; H04N 21/2187; H04N 21/2343; H04N 7/18; H04N 21/472

(52) U.S. Cl. CPC H04N 21/8545; H04N 7/181; H04N 21/47217; H04N 21/2187; H04N 21/47202; H04N 21/47205; H04N 21/234363; H04N 21/8455

(57) ABSTRACT

A video surveillance method, a surveillance server, and a surveillance system where the video surveillance method includes receiving a surveillance request sent by a client, where the surveillance request carries an identifier of a video acquiring apparatus, acquiring a real-time video from the video acquiring apparatus, acquiring real-time video superimposition information which includes an superimposition position, real-time presentation information of an agent, and agent management information, superimposing the real-time presentation information to the real-time video according to the superimposition position and superimposing the agent management information to the real-time video according to the superimposition position and in a form of an operation menu in order to generate an interactive video, and sending the interactive video to the client such that a user performs control on a call of the agent or performs setting on a status of the agent using the operation menu.

### CROSS-REFERENCE TO RELATED APPLICATIONS

This application is a continuation of International Application No. PCT/CN2014/077343, filed on May 13, 2014, which claims priority to Chinese Patent Application No. 201310450190.2, filed on Sep. 27, 2013, both of which are hereby incorporated by reference in their entireties.

### TECHNICAL FIELD

The present disclosure relates to the field of video surveillance technologies, and in particular, to a video surveillance method, a surveillance server, and a surveillance system.

### BACKGROUND

Currently, a commonly used call center surveillance system usually includes a client, a surveillance server, a configuration server, and a computer telephony integration (CTI) server. The configuration server is configured to store agent information, and the agent information includes information such as agent identity information (for example, an employee identification (ID), a job title, and a name) and information related to an office area. The CTI server is configured to monitor an agent status in order to provide agent status information (for example, status information of an agent: busy, idle, and on a call) and call statistics (for example, data such as a quantity of calls of an agent, call duration, and a frequency of calls) to the surveillance server. The CTI server is further configured to perform control (for example, control such as breaking in on a call and disconnecting a call) on an agent according to an instruction sent by the surveillance server. The surveillance server is configured to acquire the agent information from the configuration server, acquire the agent status information from the CTI server, and send the agent information and the agent status information to the client. The client draws an interface for display, and the interface includes the agent information and the agent status information such that a user learns the agent information and the agent status information of an agent and performs control on the agent according to the agent information and the agent status information.

Using the foregoing surveillance system, the surveillance server can only acquire and send the agent identity information and the agent status information to the client, and the user can only learn the agent identity information and the agent status information according to an image displayed by the client and cannot learn an actual image of the agent in real time, which may cause an inauthentic surveillance result.

### SUMMARY

In view of this, the present disclosure provides a video surveillance method, a surveillance server, and a surveillance system that enable a user to learn an actual image of an agent, thereby ensuring authenticity of a surveillance result.

According to a first aspect, an embodiment of the present disclosure provides a video surveillance method, where the method includes receiving a surveillance request sent by a client, where the surveillance request carries an identifier of a video acquiring apparatus corresponding to a surveillance area, acquiring a real-time video from the video acquiring apparatus corresponding to the identifier, acquiring real-time video superimposition information according to the identifier, where the real-time video superimposition information includes a superimposition position, real-time presentation information of an agent corresponding to the superimposition position, and agent management information corresponding to the superimposition position, superimposing the real-time presentation information on the real-time video according to the superimposition position and superimposing the agent management information in a form of an operation menu on the real-time video according to the superimposition position in order to generate an interactive video, and sending the interactive video to the client such that a user controls a call of the agent or sets a status of the agent using the operation menu in the interactive video displayed by the client.

In a first possible implementation manner of the first aspect, the real-time presentation information includes agent identity information and agent real-time status information.

With reference to the first aspect or the first possible implementation manner of the first aspect, in a second possible implementation manner, before acquiring a real-time video from the video acquiring apparatus corresponding to the identifier, the method further includes acquiring configuration information of the video acquiring apparatus according to the identifier, and performing configuration on the video acquiring apparatus according to the configuration information, where the configuration information includes a horizontal angle, a vertical angle, and a scaling parameter that are of the video acquiring apparatus, and the scaling parameter is determined according to a size of the surveillance area and a quantity of agents.

With reference to the first aspect, the first possible implementation manner of the first aspect, or the second possible implementation manner of the first aspect, in a third possible implementation manner, after sending the interactive video to the client, the method further includes storing the interactive video as a playback video, where the playback video carries the identifier, receiving a playback request sent by the client, where the playback request carries playback information, and the playback information includes the identifier and a playback time point, acquiring a playback video corresponding to the playback information, and sending the playback video to the client.

With reference to the first aspect, the first possible implementation manner of the first aspect, or the second possible implementation manner of the first aspect, in a fourth possible implementation manner, after sending the interactive video to the client, the method further includes receiving a playback request sent by the client, where the playback request carries playback information, and the playback information includes the identifier and a playback time point, acquiring a playback video from the video acquiring apparatus corresponding to the identifier according to the playback time point, acquiring playback video superimposition information according to the playback information, where the playback video superimposition information includes a superimposition position, and playback presentation information of an agent corresponding to the superimposition position, superimposing the playback presentation information on the playback video according to the superimposition position in order to generate an interactive playback video, and sending the interactive playback video to the client.

With reference to the fourth possible implementation manner of the first aspect, in a fifth possible implementation manner, the playback presentation information includes agent identity information and agent playback status information.

With reference to the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in the sixth possible implementation manner, the superimposition position is preset according to a fixed video scene corresponding to the video acquiring apparatus.

According to a second aspect, an embodiment of the present disclosure provides a video surveillance method, where the method includes acquiring, according to an identifier of a video acquiring apparatus corresponding to a surveillance area selected by a user, a real-time video from the video acquiring apparatus corresponding to the identifier, acquiring real-time video superimposition information according to the identifier, where the real-time video superimposition information includes a superimposition position, real-time presentation information of an agent corresponding to the superimposition position, and agent management information corresponding to the superimposition position, superimposing the real-time presentation information on the real-time video according to the superimposition position and superimposing the agent management information in a form of an operation menu on the real-time video according to the superimposition position in order to generate an interactive video, and displaying the interactive video such that the user uses the operation menu in the interactive video to control a call of the agent or set a status of the agent.

In a first possible implementation manner of the second aspect, the real-time presentation information includes agent identity information and agent real-time status information.

With reference to the second aspect or the first possible implementation manner of the second aspect, in a second possible implementation manner, before acquiring, according to an identifier of a video acquiring apparatus corresponding to a surveillance area selected by a user, a real-time video from the video acquiring apparatus corresponding to the identifier, the method further includes acquiring configuration information of the video acquiring apparatus according to the identifier of the video acquiring apparatus corresponding to the surveillance area selected by the user, and performing configuration on the video acquiring apparatus according to the configuration information, where the configuration information includes a horizontal angle, a vertical angle, and a scaling parameter that are of the video acquiring apparatus, and the scaling parameter is determined according to a size of the surveillance area and a quantity of agents.

With reference to the second aspect, the first possible implementation manner of the second aspect, or the second possible implementation manner of the second aspect, in a third possible implementation manner, after the displaying the interactive video, the method further includes storing the interactive video as a playback video, where the playback video carries the identifier, acquiring a playback video according to playback information selected by the user, where the playback information includes the identifier and a playback time point, and displaying the playback video.

With reference to the second aspect, the first possible implementation manner of the second aspect, or the second possible implementation manner of the second aspect, in a fourth possible implementation manner, after displaying the interactive video, the method further includes acquiring a playback video from the video acquiring apparatus corresponding to the identifier according to playback information selected by the user, where the playback information includes the identifier and a playback time point, acquiring playback video superimposition information according to the playback information, where the playback video superimposition information includes a superimposition position, and playback presentation information of an agent corresponding to the superimposition position, superimposing the playback presentation information on the playback video according to the superimposition position in order to generate an interactive playback video, and displaying the interactive playback video.

With reference to the fourth possible implementation manner of the second aspect, in a fifth possible implementation manner, the playback presentation information includes agent identity information and agent playback status information.

With reference to the second aspect, the first possible implementation manner of the second aspect, the second possible implementation manner of the second aspect, the third possible implementation manner of the second aspect, the fourth possible implementation manner of the second aspect, or the fifth possible implementation manner of the second aspect, in sixth possible implementation manner, the superimposition position is preset according to a fixed video scene corresponding to the video acquiring apparatus.

According to a third aspect, an embodiment of the present disclosure provides a surveillance server, where the surveillance server includes a receiving unit, configured to receive a surveillance request sent by a client, where the surveillance request carries an identifier of a video acquiring apparatus corresponding to a surveillance area, an acquiring unit, configured to acquire a real-time video from the video acquiring apparatus corresponding to the identifier, where the acquiring unit further acquires real-time video superimposition information according to the identifier, where the real-time video superimposition information includes a superimposition position, real-time presentation information of an agent corresponding to the superimposition position, and agent management information corresponding to the superimposition position, a generating unit, configured to superimpose the real-time presentation information on the real-time video according to the superimposition position and superimpose the agent management information in a form of an operation menu on the real-time video according to the superimposition position in order to generate an interactive video, and a sending unit, configured to send the interactive video to the client such that a user controls a call of the agent or sets a status of the agent using the operation menu in the interactive video displayed by the client.

In a first possible implementation manner of the third aspect, the real-time presentation information includes agent identity information and agent real-time status information.

With reference to the third aspect or the first possible implementation manner of the third aspect, in a second possible implementation manner, the acquiring unit is further configured to acquire configuration information of the video acquiring apparatus according to the identifier, and the surveillance server further includes a configuring unit, configured to perform configuration on the video acquiring apparatus according to the configuration information, where the configuration information includes a horizontal angle, a vertical angle, and a scaling parameter that are of the video acquiring apparatus, the horizontal angle and the vertical angle are determined according to an installation position of the video acquiring apparatus, and the scaling parameter is determined according to a size of the surveillance area and a quantity of agents.

With reference to the third aspect, the first possible implementation manner of the third aspect, or the second possible implementation manner of the third aspect, in a third possible implementation manner, the surveillance server further includes a storage unit, configured to store the interactive video as a playback video, where the playback video carries the identifier. The receiving unit is further configured to receive a playback request sent by the client, where the playback request carries playback information, and the playback information includes the identifier and a playback time point. The acquiring unit is further configured to acquire a playback video corresponding to the playback information, and the sending unit is further configured to send the playback video to the client.

With reference to the third aspect, the first possible implementation manner of the third aspect, or the second possible implementation manner of the third aspect, in a fourth possible implementation manner, the receiving unit is further configured to receive a playback request sent by the client, where the playback request carries playback information, and the playback information includes the identifier and a playback time point. The acquiring unit is further configured to acquire a playback video from the video acquiring apparatus corresponding to the identifier according to the playback time point. The acquiring unit is further configured to acquire playback video superimposition information according to the playback information, where the playback video superimposition information includes a superimposition position, and playback presentation information of an agent corresponding to the superimposition position. The generating unit is further configured to superimpose the playback presentation information on the playback video according to the superimposition position in order to generate an interactive playback video, and the sending unit is further configured to send the interactive playback video to the client.

With reference to the fourth possible implementation manner of the third aspect, in a fifth possible implementation manner, the playback presentation information includes agent identity information and agent playback status information.

With reference to the third aspect, the first possible implementation manner of the third aspect, the second possible implementation manner of the third aspect, the third possible implementation manner of the third aspect, the fourth possible implementation manner of the third aspect, or the fifth possible implementation manner of the third aspect, in sixth possible implementation manner, the superimposition position is preset according to a fixed video scene corresponding to the video acquiring apparatus and the configuration information.

According to a fourth aspect, an embodiment of the present disclosure provides a surveillance system, where the system includes a client, a video acquiring apparatus, and the surveillance server described in the third aspect.

In a first possible implementation manner of the fourth aspect, the system further includes a configuration server, and real-time video superimposition information and playback video superimposition information that are acquired by the surveillance server are acquired from the configuration server.

According to a fifth aspect, an embodiment of the present disclosure provides a client, and the client includes an acquiring unit, configured to acquire, according to an identifier of a video acquiring apparatus corresponding to a surveillance area selected by a user, a real-time video from the video acquiring apparatus corresponding to the identifier, where the acquiring unit is further configured to acquire real-time video superimposition information according to the identifier, where the real-time video superimposition information includes a superimposition position, real-time presentation information of an agent corresponding to the superimposition position, and agent management information corresponding to the superimposition position, a generating unit, configured to superimpose the real-time presentation information on the real-time video according to the superimposition position and superimpose the agent management information in a form of an operation menu on the real-time video according to the superimposition position in order to generate an interactive video, and a displaying unit, configured to display the interactive video such that the user uses the operation menu in the interactive video to control a call of the agent or set a status of the agent.

In a first possible implementation manner of the fifth aspect, the real-time presentation information includes agent identity information and agent real-time status information.

With reference to the fifth aspect or the first possible implementation manner of the fifth aspect, in a second possible implementation manner, the acquiring unit is further configured to acquire configuration information of the video acquiring apparatus according to the identifier of the video acquiring apparatus corresponding to the surveillance area selected by the user, and the client further includes a configuring unit, configured to perform configuration on the video acquiring apparatus according to the configuration information, where the configuration information includes a horizontal angle, a vertical angle, and a scaling parameter that are of the video acquiring apparatus, and the scaling parameter is determined according to a size of the surveillance area and a quantity of agents.

With reference to the fifth aspect, the first possible implementation manner of the fifth aspect, or the second possible implementation manner of the fifth aspect, in a third possible implementation manner, the client further includes a storage unit, configured to store the interactive video as a playback video, where the playback video carries the identifier, where the acquiring unit is further configured to acquire a playback video according to playback information selected by the user, where the playback information includes the identifier and a playback time point, and the displaying unit is further configured to display the playback video.

With reference to the fifth aspect, the first possible implementation manner of the fifth aspect, or the second possible implementation manner of the fifth aspect, in a fourth possible implementation manner, the acquiring unit is further configured to acquire a playback video from the video acquiring apparatus corresponding to the identifier according to playback information selected by the user, where the playback information includes the identifier and a playback time point. The acquiring unit is further configured to acquire playback video superimposition information according to the playback information, where the playback video superimposition information includes a superimposition position, and playback presentation information of an agent corresponding to the superimposition position. The generating unit is further configured to superimpose the playback presentation information on the playback video according to the superimposition position in order to generate an interactive playback video, and the displaying unit is further configured to display the interactive playback video.

With reference to the fourth possible implementation manner of the fifth aspect, in a fifth possible implementation manner, the playback presentation information includes agent identity information and agent playback status information.

With reference to the fifth aspect, the first possible implementation manner of the fifth aspect, the second possible implementation manner of the fifth aspect, the third possible implementation manner of the fifth aspect, the fourth possible implementation manner of the fifth aspect, or the fifth possible implementation manner of the fifth aspect, in sixth possible implementation manner, the superimposition position is preset according to a fixed video scene corresponding to the video acquiring apparatus.

According to a sixth aspect, an embodiment of the present disclosure provides a surveillance system, where the system includes the client described in the fifth aspect, and a video acquiring apparatus.

In a first possible implementation manner of the sixth aspect, the system further includes a configuration server, and real-time video superimposition information and playback video superimposition information that are acquired by the client are acquired from the configuration server.

Using the video surveillance method, and the surveillance server and system provided in embodiments of the present disclosure, real-time presentation information and an acquired real-time video are superimposed according to a superimposition position and agent management information in a form of an operation menu and the acquired real-time video are superimposed according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

### BRIEF DESCRIPTION OF DRAWINGS

FIG. 1 is a schematic flowchart of a video surveillance method according to Embodiment 1 of the present disclosure;

FIG. 2 is a schematic flowchart of a process of video playback in a video surveillance method according to Embodiment 1 of the present disclosure;

FIG. 3 is a schematic flowchart of another process of video playback in a video surveillance method according to Embodiment 1 of the present disclosure;

FIG. 4 is a schematic flowchart of a video surveillance method according to Embodiment 2 of the present disclosure;

FIG. 5 is a schematic flowchart of a process of video playback in a video surveillance method according to Embodiment 2 of the present disclosure;

FIG. 6 is a schematic flowchart of another process of video playback in a video surveillance method according to Embodiment 2 of the present disclosure;

FIG. 7 is a schematic diagram of a structure of a surveillance server according to Embodiment 3 of the present disclosure;

FIG. 8 is a schematic diagram of a structure of another surveillance server according to Embodiment 3 of the present disclosure;

FIG. 9 is a schematic diagram of a structure of still another surveillance server according to Embodiment 3 of the present disclosure;

FIG. 10 is a schematic diagram of a structure of a surveillance server according to Embodiment 4 of the present disclosure;

FIG. 11 is a schematic diagram of a structure of a surveillance system according to Embodiment 5 of the present disclosure;

FIG. 12 is a schematic diagram of a structure of a client according to Embodiment 6 of the present disclosure;

FIG. 13 is a schematic diagram of a structure of another client according to Embodiment 6 of the present disclosure;

FIG. 14 is a schematic diagram of a structure of still another client according to Embodiment 6 of the present disclosure;

FIG. 15 is a schematic diagram of a structure of a client according to Embodiment 7 of the present disclosure; and

FIG. 16 is a schematic diagram of a structure of a surveillance system according to Embodiment 8 of the present disclosure.

### DESCRIPTION OF EMBODIMENTS

To make the objectives, technical solutions, and advantages of the present disclosure clearer, the following further describes the present disclosure in detail with reference to the accompanying drawings. The described embodiments are merely some but not all of the embodiments of the present disclosure. All other embodiments obtained by a person of ordinary skill in the art based on the embodiments of the present disclosure without creative efforts shall fall within the protection scope of the present disclosure.

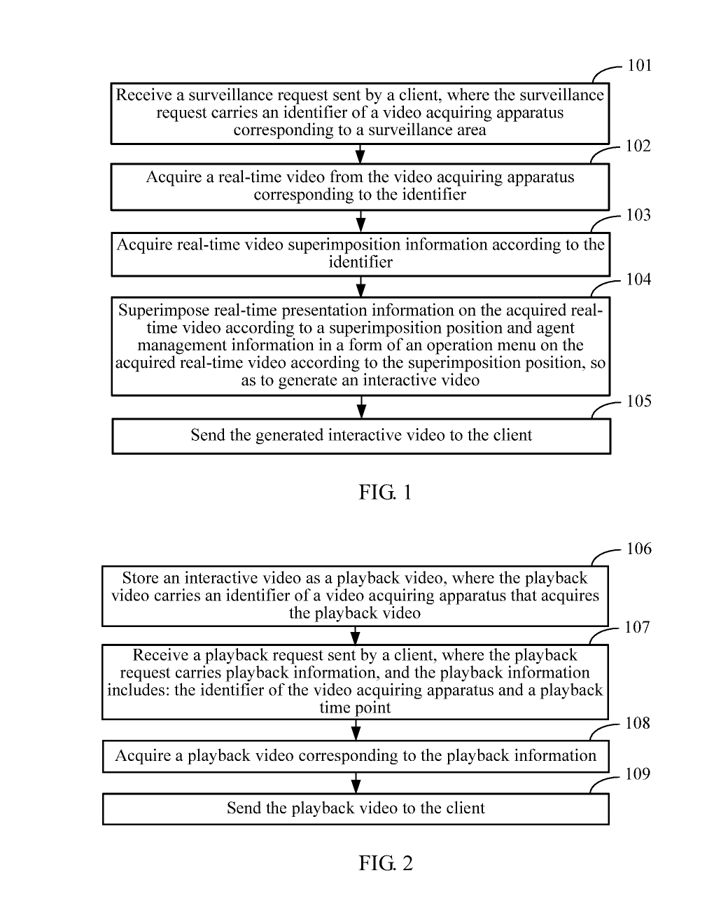

The following uses FIG. 1 as an example to describe in detail a video surveillance method provided in Embodiment 1 of the present disclosure, and FIG. 1 is a schematic flowchart of the video surveillance method according to Embodiment 1 of the present disclosure. The video surveillance method is executed by a surveillance server. As shown in FIG. 1, the video surveillance method includes the following steps.

Step 101: Receive a surveillance request sent by a client, where the surveillance request carries an identifier of a video acquiring apparatus corresponding to a surveillance area.

The identifier of the video acquiring apparatus may be a serial number of the video acquiring apparatus, may be an ID number allocated by the surveillance server to the video acquiring apparatus, or the like.

Step 102: Acquire a real-time video from the video acquiring apparatus corresponding to the identifier.

Each surveillance area corresponds to one video acquiring apparatus, for example, a video camera. The video acquiring apparatus may be disposed on a top or on a wall in the surveillance area. Before the video acquiring apparatus acquires a video, the video acquiring apparatus needs to be configured in order to ensure that the video acquiring apparatus acquires a same video scene each time, including a same position of an agent, a same size, a same angle, and the like.

Therefore, before acquiring a real-time video from the video acquiring apparatus corresponding to the identifier, the video surveillance method further includes acquiring configuration information of the video acquiring apparatus corresponding to the surveillance area from a configuration server according to the identifier, and then performing configuration on the video acquiring apparatus according to the acquired configuration information.

The configuration information includes information such as a horizontal angle, a vertical angle, and a scaling parameter that are of the video acquiring apparatus. The configuration information is preset according to an actual situation of the surveillance area. For example, the scaling parameter is pre-adjusted according to a size of the surveillance area and a quantity of agents, and the horizontal angle and the vertical angle are adjusted according to an actual installation position of the video acquiring apparatus in order to determine a set of optimal configuration information. The configuration information of the video acquiring apparatus corresponding to each surveillance area is stored in the configuration server. When a video of a surveillance area needs to be acquired, the surveillance server acquires configuration information of a video acquiring apparatus corresponding to the surveillance area from the configuration server according to an identifier in order to configure the video acquiring apparatus.

Step 103: Acquire real-time video superimposition information according to the identifier.

The real-time video superimposition information may be acquired from the configuration server.

The real-time video superimposition information includes a superimposition position, real-time presentation information of an agent corresponding to the superimposition position, and agent management information corresponding to the superimposition position.

The superimposition position is a position that is in a real-time video and to which real-time presentation information and an operation menu are added. The superimposition position is arranged around an agent displayed in the video, and each superimposition position occupies one placeholder in the video. The superimposition position is preset according to a fixed video scene corresponding to a video acquiring apparatus. When the configuration information of the video acquiring apparatus is preset, the fixed video scene corresponding to the video acquiring apparatus can be determined, and then, a superimposition position corresponding to each agent is set according to the fixed video scene. A determined superimposition position in each surveillance area is pre-stored in the configuration server. When the fixed video scene changes, for example, when an agent in the surveillance area changes and the configuration information changes, the superimposition position needs to be reset.

The real-time presentation information of an agent corresponding to a superimposition position includes agent identity information (for example, an employee ID, a job title, and a name), and agent real-time status information (for example, status information of the agent: busy, idle, and on a call). The agent identity information is pre-stored in the configuration server, and the agent real-time status information may be acquired from a CTI server by the configuration server.

The agent management information corresponding to a superimposition position may include control information such as intercepting a call, breaking in on a call, and disconnecting a call, and setting information for setting a status of an agent to a specified state. The agent management information may be pre-configured and stored in the configuration server according to a requirement of a user.

Step 104: Superimpose real-time presentation information on the acquired real-time video according to a superimposition position and superimpose agent management information in a form of an operation menu on the acquired real-time video according to the superimposition position in order to generate an interactive video.

Because each surveillance area corresponds to a fixed video acquiring apparatus, and same configuration is performed on a video acquiring apparatus corresponding to a same surveillance area each time, a video scene acquired by the video acquiring apparatus corresponding to the same surveillance area each time is the same. Therefore, presentation information and an operation menu can be accurately added around each agent in an acquired real-time video according to video superimposition information.

Real-time presentation information of each agent and the acquired real-time video are superimposed according to a superimposition position corresponding to each agent, and agent management information in a form of an operation menu and the acquired real-time video are superimposed according to the superimposition position such that the user controls a call of each agent or sets a status of each agent using the operation menu.

Step 105: Send the generated interactive video to the client.

The interactive video includes the real-time video acquired by the video acquiring apparatus, agent identity information and agent real-time status information of each agent, and an operation menu for each agent. Therefore, using the interactive video, the user can not only learn agent information and the real-time status information of each agent, but also learn an actual situation of each agent, for example, whether an agent operator is at a workstation, and an action and a facial expression of an agent operator. In addition, the user may use the operation menu to control a call of the agent and/or set a status of the agent.

Controlling a call of the agent may include controlling such as intercepting a call, breaking in on a call to form a three-way call, and disconnecting a call.

Setting a status of the agent may include setting the agent to be idle, setting the agent to be busy, and the like.

Furthermore, the client instructs the CTI server to set a status of the agent according to an agent status selected by the user, and the CTI server performs a corresponding setting on the status of the agent. Specific implementation may be as follows. When the user instructs to set the status of the agent using the operation menu, the surveillance server instructs, after receiving an instruction sent by the client for setting an agent status, the CTI server to set the status of the agent according to the instruction for setting an agent status, and the CTI server performs a corresponding setting on the status of the agent. Correspondingly, real-time status information, of the agent, acquired from the CTI server by the configuration server in this case is a currently set status (for example, busy).

In a specific example, the interactive video displays that an agent is in an idle state (that is, a service may be provided currently), but there is no agent operator at a workstation of the agent. To avoid a case in which a call is connected but receives no answer, the user may directly set a status of the agent to be busy or agent operator being not at a workstation using an operation menu that is in the interactive video and corresponding to the agent.

Using the video surveillance method provided in Embodiment 1 of the present disclosure, a surveillance server superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

In addition, the video surveillance method provided in Embodiment 1 of the present disclosure may further be used for video playback.

Optionally, as shown in FIG. 2, FIG. 2 is a schematic flowchart of a process of video playback in the video surveillance method according to Embodiment 1 of the present disclosure. In step 105, after sending the generated interactive video to the client, the video surveillance method may further include the following steps.

Step 106: Store the interactive video as a playback video, where the playback video carries the identifier of the video acquiring apparatus that acquires the playback video.

The playback video is stored in an internal memory or an external memory of the surveillance server.

In addition, because space for storing a playback video is limited, a storage period may be set in the surveillance server. For example, only a video acquired within an hour prior to a current moment is stored, and a video acquired more than one hour prior to the current moment is deleted and is replaced with a current video that is newly acquired.

Step 107: Receive a playback request sent by the client, where the playback request carries playback information, and the playback information includes the identifier of the video acquiring apparatus and a playback time point.

Step 108: Acquire a playback video corresponding to the playback information.

Because all previous interactive videos are stored as playback videos in the internal memory or the external memory of the surveillance server, a playback video required by the user may be acquired from the internal memory or the external memory of the surveillance server according to a playback time point and an identifier of a video acquiring apparatus corresponding to a surveillance area that needs to be viewed by the user.

Step 109: Send the playback video to the client.

The playback video includes an actual image of each agent in the surveillance area at the time point required by the user for viewing, and agent information and agent status information of each agent at the time, which can meet a requirement that the user views an earlier actual situation of the surveillance area.

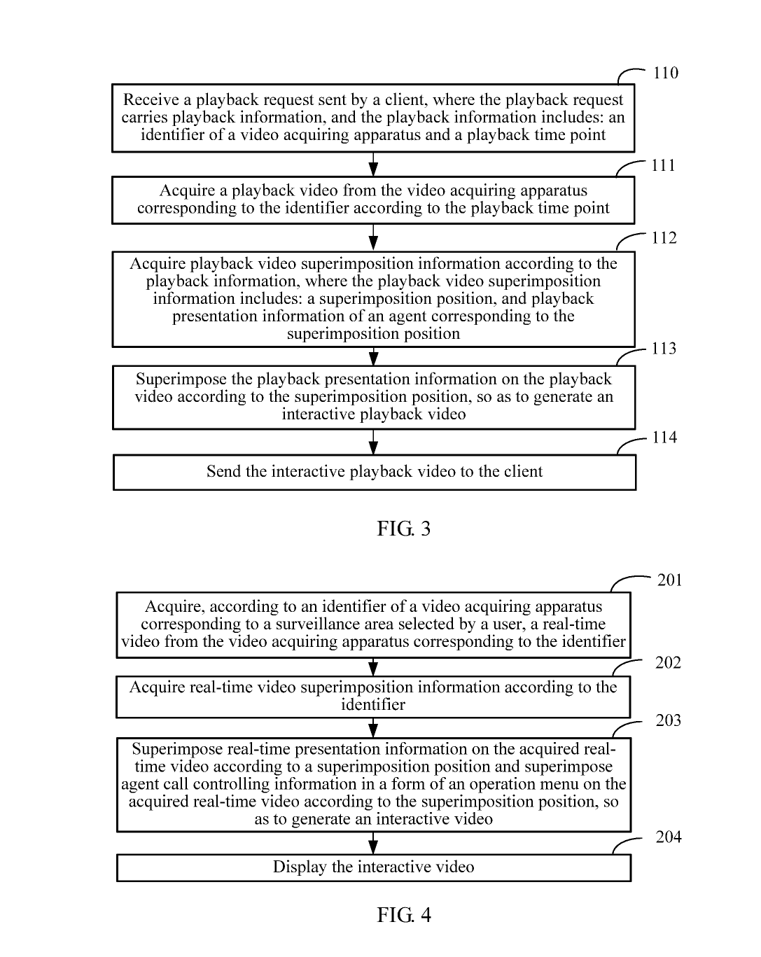

Optionally, as shown in FIG. 3, FIG. 3 is a schematic flowchart of another process of video playback in the video surveillance method according to Embodiment 1 of the present disclosure. In step 105, after the sending the generated interactive video to the client, the video surveillance method may further include the following steps.

Step 110: Receive a playback request sent by the client, where the playback request carries playback information, and the playback information includes the identifier of the video acquiring apparatus and a playback time point.

Step 111: Acquire a playback video from the video acquiring apparatus corresponding to the identifier according to the playback time point.

The video acquiring apparatus stores the previously acquired video as a playback video. Then, after receiving the playback request, the surveillance server first determines, according to the identifier of the video acquiring apparatus, the video acquiring apparatus that acquires the playback video, and then may acquire a corresponding playback video from the determined video acquiring apparatus according to the playback time point.

Step 112: Acquire playback video superimposition information according to the playback information, where the playback video superimposition information includes a superimposition position, and playback presentation information of an agent corresponding to the superimposition position.

The playback video superimposition information may be acquired from the configuration server.

The playback presentation information includes agent identity information and agent playback status information. The configuration server stores previous agent real-time status information as agent playback status information in the configuration server. Then, the surveillance server may acquire, from the configuration server according to a playback time point and an identifier of a video acquiring apparatus corresponding to a surveillance area that needs to be viewed by the user, playback video superimposition information corresponding to a playback video required by the user.

Step 113: Superimpose the playback presentation information on the playback video according to the superimposition position in order to generate an interactive playback video.

The currently used video is a playback video, adding an operation menu to the playback video is of little significance, and the user needs to be provided only with a real image of an agent at a time point required by the user, agent identity information, and agent status information at the time point required by the user. Therefore, an interactive playback video is generated only by superimposing playback presentation information on a playback video.

Step 114: Send the interactive playback video to the client.

The interactive playback video includes an actual image of each agent in the surveillance area at the time point required by the user for viewing, and agent identity information and agent status information of each agent at the time, which can meet a requirement that the user views an earlier actual situation of the surveillance area.

The following uses FIG. 4 as an example to describe in detail a video surveillance method provided in Embodiment 2 of the present disclosure, and FIG. 4 is a schematic flowchart of the video surveillance method according to Embodiment 2 of the present disclosure. The video surveillance method is executed by a client. As shown in FIG. 4, the video surveillance method includes the following steps.

Step 201: Acquire, according to an identifier of a video acquiring apparatus corresponding to a surveillance area selected by a user, a real-time video from the video acquiring apparatus corresponding to the identifier.

The identifier of the video acquiring apparatus may be a serial number of the video acquiring apparatus, may be an ID allocated by a surveillance server to the video acquiring apparatus, or the like.

Each surveillance area corresponds to one video acquiring apparatus, for example, a video camera. The video acquiring apparatus may be disposed on a top or on a wall in the surveillance area. Before the video acquiring apparatus acquires a video, the video acquiring apparatus needs to be configured in order to ensure that the video acquiring apparatus acquires a same video scene each time, including a same position of an agent, a same size, a same angle, and the like.

Therefore, before acquiring a real-time video from the video acquiring apparatus corresponding to the identifier, the video surveillance method further includes acquiring configuration information of the video acquiring apparatus corresponding to the surveillance area from a configuration server according to the identifier, and then performing configuration on the video acquiring apparatus according to the acquired configuration information.

The configuration information includes information such as a horizontal angle, a vertical angle, and a scaling parameter that are of the video acquiring apparatus. The configuration information is preset according to an actual situation of the surveillance area. For example, the scaling parameter is pre-adjusted according to a size of the surveillance area and a quantity of agents, and the horizontal angle and the vertical angle are adjusted according to an actual installation position of the video acquiring apparatus in order to determine a set of optimal configuration information. The configuration information of the video acquiring apparatus corresponding to each surveillance area is stored in the configuration server. When a video of a surveillance area needs to be acquired, the surveillance server acquires configuration information of a video acquiring apparatus corresponding to the surveillance area from the configuration server according to an identifier in order to configure the video acquiring apparatus.

Step 202: Acquire real-time video superimposition information according to the identifier.

The real-time video superimposition information may be acquired from the configuration server.

The real-time video superimposition information includes a superimposition position, real-time presentation information of an agent corresponding to the superimposition position, and agent management information corresponding to the superimposition position.

The superimposition position is a position that is in a real-time video and to which real-time presentation information and an operation menu are added. The superimposition position is arranged around an agent displayed in the video, and each superimposition position occupies one placeholder in the video. The superimposition position is preset according to a fixed video scene corresponding to a video acquiring apparatus. When the configuration information of the video acquiring apparatus is preset, the fixed video scene corresponding to the video acquiring apparatus can be determined, and then, a superimposition position corresponding to each agent is set according to the fixed video scene. A determined superimposition position in each surveillance area is pre-stored in the configuration server. When the fixed video scene changes, for example, when an agent in the surveillance area changes and the configuration information changes, the superimposition position needs to be reset.

The real-time presentation information of an agent corresponding to a superimposition position includes agent identity information (for example, an employee ID, a job title, and a name), and agent real-time status information (for example, status information of the agent: busy, idle, and on a call). The agent identity information is pre-stored in the configuration server, and the agent real-time status information may be acquired from a CTI server by the configuration server.

The agent management information corresponding to a superimposition position may include control information such as intercepting a call, breaking in on a call, and disconnecting a call, and setting information for setting a status of an agent to a specified state. The agent management information may be pre-configured and stored in the configuration server according to a requirement of the user.

Step 203: Superimpose real-time presentation information on the acquired real-time video according to a superimposition position and superimpose agent call controlling information in a form of an operation menu on the acquired real-time video according to the superimposition position in order to generate an interactive video.

Because each surveillance area corresponds to a fixed video acquiring apparatus, and same configuration is performed on a video acquiring apparatus corresponding to a same surveillance area each time, a video scene acquired by the video acquiring apparatus corresponding to the same surveillance area each time is the same. Therefore, presentation information and an operation menu can be accurately added around each agent in an acquired real-time video according to video superimposition information.

Real-time presentation information of each agent and the acquired real-time video are superimposed according to a superimposition position corresponding to each agent and agent management information in a form of an operation menu and the acquired real-time video are superimposed according to the superimposition position such that the user controls a call of each agent or sets a status of each agent using the operation menu.

Step 204: Display the interactive video.

The interactive video includes the real-time video acquired by the video acquiring apparatus, agent identity information and agent real-time status information of each agent, and an operation menu for each agent. Therefore, using the interactive video, the user can not only learn agent information and the real-time status information of each agent, but also learn an actual situation of each agent, for example, whether an agent operator is at a workstation, and an action and a facial expression of an agent operator. In addition, the user may use the operation menu to control a call of the agent and/or set a status of the agent.

Controlling a call of the agent may include controlling such as intercepting a call, breaking in on a call to form a three-way call, and disconnecting a call.

Setting a status of the agent may include setting the agent to be idle, setting the agent to be busy, and the like.

Furthermore, the client instructs the CTI server to set a status of the agent according to an agent status selected by the user, and the CTI server performs a corresponding setting on the status of the agent. Specific implementation may be as follows. When the user instructs to set the status of the agent using the operation menu, the client sends an instruction for setting an agent status to the CTI server in order to instruct the CTI server to set the status of the agent according to the instruction for setting an agent status, and the CTI server sets the status of the agent to a status (for example, busy) specified in the instruction for setting an agent status.

In a specific example, the interactive video displays that an agent is in an idle state, but there is no agent operator at a workstation of the agent. To avoid a case in which a call is connected but receives no answer, the user may directly set a status of the agent to be busy using an operation menu that is in the interactive video and corresponding to the agent.

Using the video surveillance method provided in Embodiment 2 of the present disclosure, a client superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

In addition, the video surveillance method provided in Embodiment 2 of the present disclosure may further be used for video playback.

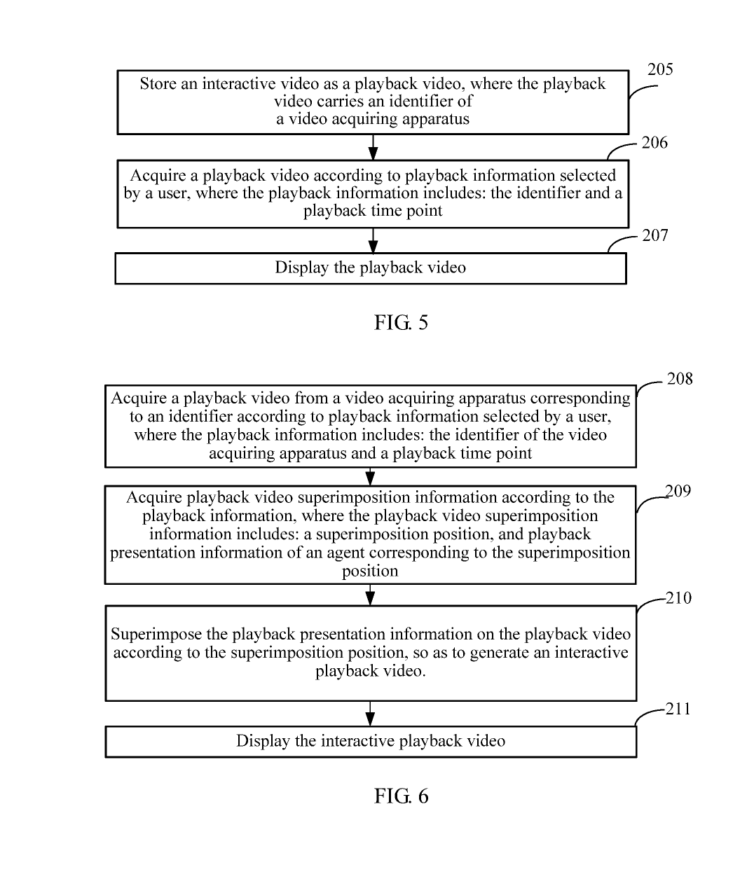

Optionally, as shown in FIG. 5, FIG. 5 is a schematic flowchart of a process of video playback in the video surveillance method according to Embodiment 2 of the present disclosure. In step 204, after displaying the interactive video, the video surveillance method may further include the following steps.

Step 205: Store the interactive video as a playback video, where the playback video carries the identifier of a video acquiring apparatus.

The playback video is stored in an internal memory or an external memory of the client.

In addition, because space for storing a playback video is limited, a storage period may be set on the client. For example, only a video acquired within an hour prior to a current moment is stored, and a video acquired more than one hour prior to the current moment is deleted and is replaced with a current video that is newly acquired.

Step 206: Acquire a playback video according to playback information selected by the user, where the playback information includes the identifier of the video acquiring apparatus and a playback time point.

Because all previous interactive videos are stored as playback videos in the internal memory or the external memory of the client, a playback video required by the user may be acquired from the internal memory or the external memory of the client according to a playback time point and an identifier of a video acquiring apparatus corresponding to a surveillance area that needs to be viewed by the user.

Step 207: Display the playback video.

The playback video includes an actual image of each agent in the surveillance area at the time point required by the user for viewing, and agent information and agent status information of each agent at the time, which can meet a requirement that the user views an earlier actual situation of the surveillance area.

Optionally, as shown in FIG. 6, FIG. 6 is a schematic flowchart of another process of video playback in the video surveillance method according to Embodiment 2 of the present disclosure. In step 204, after displaying the interactive video, the video surveillance method may further include the following steps.

Step 208: Acquire a playback video from the video acquiring apparatus corresponding to the identifier according to playback information selected by the user, where the playback information includes the identifier of the video acquiring apparatus and a playback time point.

The video acquiring apparatus stores the previously acquired video as a playback video. Then, according to the playback information selected by the user, the client first determines, according to the identifier of the video acquiring apparatus, the video acquiring apparatus that acquires the playback video, and then may acquire a corresponding playback video from the determined video acquiring apparatus according to the playback time point.

Step 209: Acquire playback video superimposition information according to the playback information, where the playback video superimposition information includes a superimposition position, and playback presentation information of an agent corresponding to the superimposition position.

The playback video superimposition information may be acquired from the configuration server.

The playback presentation information includes agent identity information and agent playback status information. The configuration server stores previous agent real-time status information as agent playback status information in the configuration server. Then, the client may acquire, from the configuration server according to a playback time point and an identifier of a video acquiring apparatus corresponding to a surveillance area that needs to be viewed by the user, playback video superimposition information corresponding to a playback video required by the user.

Step 210: Superimpose the playback presentation information on the playback video according to the superimposition position in order to generate an interactive playback video.

The currently used video is a playback video, adding an operation menu to the playback video is of little significance, and the user needs to be provided only with a real image of an agent at a time point required by the user, agent identity information, and agent status information at the time point required by the user. Therefore, an interactive playback video is generated only by superimposing playback presentation information on a playback video.

Step 211: Display the interactive playback video.

The interactive playback video includes an actual image of each agent in the surveillance area at the time point required by the user for viewing, and agent identity information and agent status information of each agent at the time, which can meet a requirement that the user views an earlier actual situation of the surveillance area.

The following uses FIG. 7 as an example to describe in detail a surveillance server provided in Embodiment 3 of the present disclosure, and FIG. 7 is a schematic diagram of a structure of the surveillance server according to Embodiment 3 of the present disclosure. This surveillance server is used to implement the video surveillance method shown in FIG. 1.

As shown in FIG. 7, the surveillance server includes a receiving unit 310, an acquiring unit 320, a generating unit 330, and a sending unit 340.

The receiving unit 310 is configured to receive a surveillance request sent by a client, where the surveillance request carries an identifier of a video acquiring apparatus corresponding to a surveillance area.

The identifier of the video acquiring apparatus may be a serial number of the video acquiring apparatus, may be an ID allocated by the surveillance server to the video acquiring apparatus, or the like.

The acquiring unit 320 is configured to acquire a real-time video from the video acquiring apparatus corresponding to the identifier.

Each surveillance area corresponds to one video acquiring apparatus, for example, a video camera. The video acquiring apparatus may be disposed on a top or on a wall in the surveillance area. Before the video acquiring apparatus acquires a video, the video acquiring apparatus needs to be configured in order to ensure that the video acquiring apparatus acquires a same video scene each time, including a same position of an agent, a same size, a same angle, and the like.

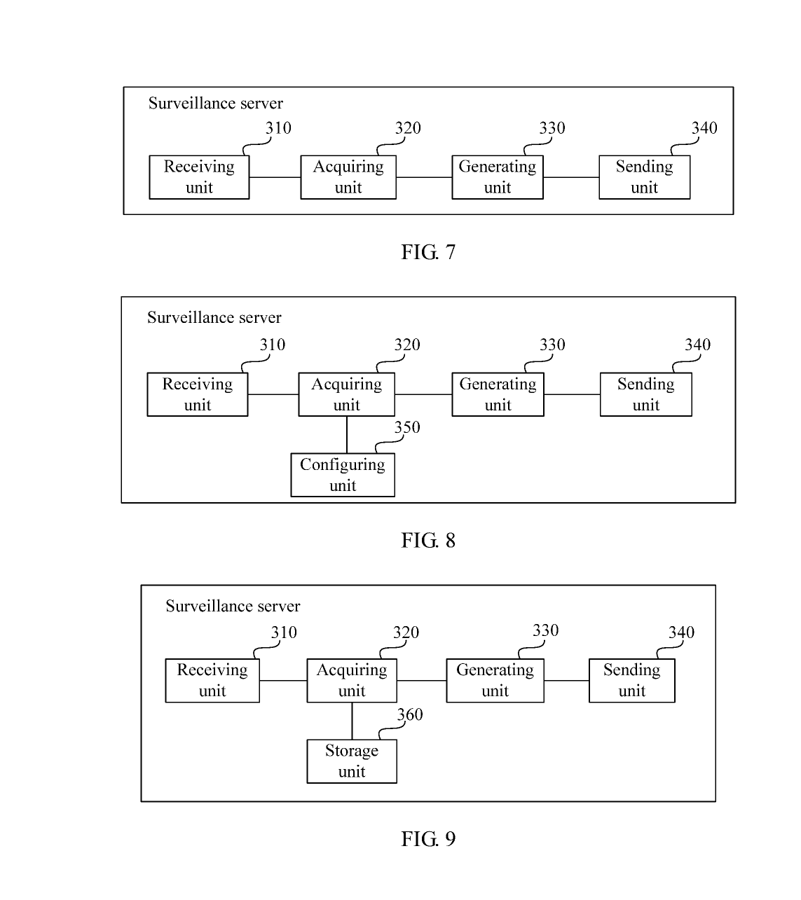

Therefore, as shown in FIG. 8, the surveillance server may further include a configuring unit 350. Before acquiring the real-time video from the video acquiring apparatus corresponding to the identifier, the acquiring unit 320 acquires configuration information of the video acquiring apparatus corresponding to the surveillance area from a configuration server according to the identifier. The configuring unit 350 performs configuration on the video acquiring apparatus according to the acquired configuration information.

The configuration information includes information such as a horizontal angle, a vertical angle, and a scaling parameter that are of the video acquiring apparatus. The configuration information is preset according to an actual situation of the surveillance area. For example, the scaling parameter is pre-adjusted according to a size of the surveillance area and a quantity of agents, and the horizontal angle and the vertical angle are adjusted according to an actual installation position of the video acquiring apparatus in order to determine a set of optimal configuration information.

The acquiring unit 320 is further configured to acquire real-time video superimposition information according to the identifier.

The acquiring unit 320 may acquire the real-time video superimposition information from the configuration server.

The real-time video superimposition information includes a superimposition position, real-time presentation information of an agent corresponding to the superimposition position, and agent management information corresponding to the superimposition position.

The superimposition position is a position that is in a real-time video and to which real-time presentation information and an operation menu are added. The superimposition position is arranged around an agent displayed in the video, and each superimposition position occupies one placeholder in the video. The superimposition position is preset according to a fixed video scene corresponding to a video acquiring apparatus. When the configuration information of the video acquiring apparatus is preset, the fixed video scene corresponding to the video acquiring apparatus can be determined, and then, a superimposition position corresponding to each agent is set according to the fixed video scene. A determined superimposition position in each surveillance area is pre-stored in the configuration server. When the fixed video scene changes, for example, when an agent in the surveillance area changes and the configuration information changes, the superimposition position needs to be reset.

The real-time presentation information of an agent corresponding to a superimposition position includes agent identity information (for example, an employee ID, a job title, and a name), and agent real-time status information (for example, status information of the agent: busy, idle, and on a call). The agent identity information is pre-stored in the configuration server, and the agent real-time status information may be acquired from a CTI server by the configuration server.

The agent management information corresponding to a superimposition position may include control information such as intercepting a call, breaking in on a call, and disconnecting a call, and setting information for setting a status of an agent to a specified state. The agent management information may be pre-configured and stored in the configuration server according to a requirement of a user.

The generating unit 330 is configured to superimpose the real-time presentation information on the acquired real-time video according to the superimposition position and superimpose the agent management information in a form of an operation menu on the acquired real-time video according to the superimposition position in order to generate an interactive video.

Because each surveillance area corresponds to a fixed video acquiring apparatus, and same configuration is performed on a video acquiring apparatus corresponding to a same surveillance area each time, a video scene acquired by the video acquiring apparatus corresponding to the same surveillance area each time is the same. Therefore, presentation information and an operation menu can be accurately added around each agent in an acquired real-time video according to video superimposition information. The sending unit 340 is configured to send the generated interactive video to the client.

The interactive video includes the real-time video acquired by the video acquiring apparatus, agent identity information and agent real-time status information of each agent, and an operation menu for each agent. Therefore, using the interactive video, the user can not only learn agent information and the real-time status information of each agent, but also learn an actual situation of each agent, for example, whether an agent operator is at a workstation, and an action and a facial expression of an agent operator. In addition, the user may use the operation menu to control a call of the agent and/or set a status of the agent.

Controlling a call of the agent may include controlling such as intercepting a call, breaking in on a call to form a three-way call, and disconnecting a call.

Setting a status of the agent may include setting the agent to be idle, setting the agent to be busy, and the like.

Using the surveillance server provided in Embodiment 3 of the present disclosure, the surveillance server superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the surveillance server, thereby ensuring authenticity of a surveillance result.

Optionally, as shown in FIG. 9, the surveillance server provided in Embodiment 3 of the present disclosure may further include a storage unit 360. The surveillance server shown in FIG. 9 implements the method for video playback shown in FIG. 2.

The storage unit 360 is configured to store the interactive video as a playback video, where the playback video carries the identifier of the video acquiring apparatus that acquires the playback video.

The playback video is stored in an internal memory or an external memory of the surveillance server.

The receiving unit 310 is further configured to receive a playback request sent by the client, where the playback request carries playback information, and the playback information includes the identifier of the video acquiring apparatus and a playback time point.

The acquiring unit 320 is further configured to acquire a playback video corresponding to the playback information. Because all previous interactive videos are stored as playback videos in the internal memory or the external memory of the surveillance server, the acquiring unit 320 may acquire a playback video required by the user from the internal memory or the external memory of the surveillance server according to a playback time point and an identifier of a video acquiring apparatus corresponding to a surveillance area that needs to be viewed by the user.

The sending unit 340 is further configured to send the playback video to the client.

The playback video includes an actual image of each agent in the surveillance area at the time point required by the user for viewing, and agent information and agent status information of each agent at the time, which can meet a requirement that the user views an earlier actual situation of the surveillance area.

Optionally, the surveillance server shown in FIG. 7 implements the method for video playback shown in FIG. 3.

The receiving unit 310 is further configured to receive a playback request sent by the client, where the playback request carries playback information, and the playback information includes the identifier of the video acquiring apparatus and a playback time point.

The acquiring unit 320 is further configured to acquire a playback video from the video acquiring apparatus corresponding to the identifier according to the playback time point.

The video acquiring apparatus stores the previously acquired video as a playback video. Then, after the receiving unit 310 receives the playback request, the acquiring unit 320 first determines, according to the identifier of the video acquiring apparatus, the video acquiring apparatus that acquires the playback video, and then may acquire a corresponding playback video from the determined video acquiring apparatus according to the playback time point.

The acquiring unit 320 is further configured to acquire playback video superimposition information according to the playback information, where the playback video superimposition information includes a superimposition position, and playback presentation information of an agent corresponding to the superimposition position.

The acquiring unit 320 may acquire the playback video superimposition information from the configuration server.

The playback presentation information includes agent identity information and agent playback status information. The configuration server stores previous agent real-time status information as agent playback status information in the configuration server. Then, the acquiring unit 320 may acquire, from the configuration server according to a playback time point and an identifier of a video acquiring apparatus corresponding to a surveillance area that needs to be viewed by the user, playback video superimposition information corresponding to a playback video required by the user.

The generating unit 330 is further configured to superimpose the playback presentation information on the playback video according to the superimposition position in order to generate an interactive playback video.

The currently used video is a playback video, adding an operation menu to the playback video is of little significance, and the user needs to be provided only with a real image of an agent at a time point required by the user, agent identity information, and agent status information at the time point required by the user. Therefore, an interactive playback video is generated only by superimposing playback presentation information on a playback video.

The sending unit 340 is further configured to send the interactive playback video to the client.

The interactive playback video includes an actual image of each agent in the surveillance area at the time point required by the user for viewing, and agent identity information and agent status information of each agent at the time, which can meet a requirement that the user views an earlier actual situation of the surveillance area.

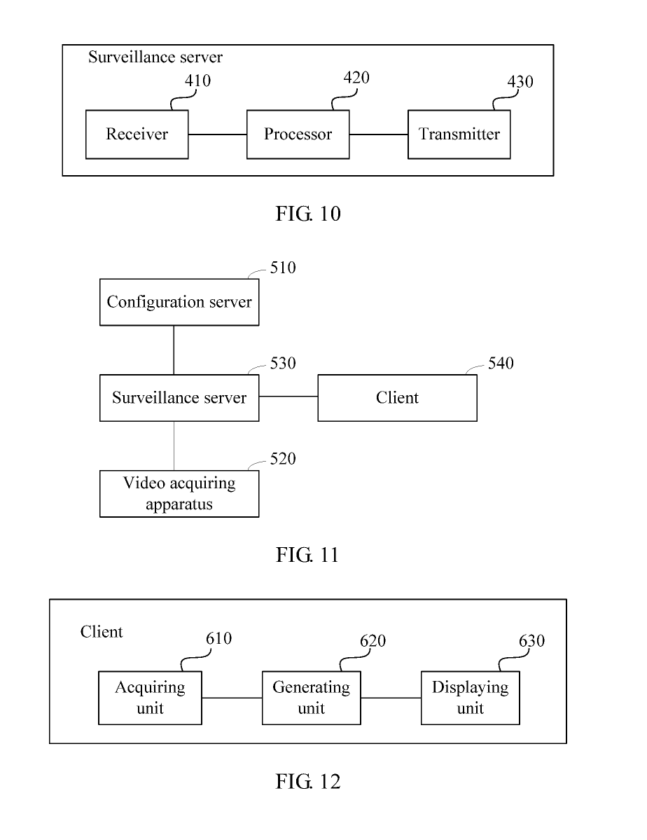

The following uses FIG. 10 as an example to describe in detail a surveillance server provided in Embodiment 4 of the present disclosure, and FIG. 10 is a schematic diagram of a structure of the surveillance server according to Embodiment 4 of the present disclosure. The surveillance server is used to implement the video surveillance method in Embodiment 1 of the present disclosure. As shown in FIG. 10, the surveillance server includes a receiver 410, a processor 420, and a transmitter 430.

The receiver 410 is configured to receive a surveillance request sent by a client, where the surveillance request carries an identifier of a video acquiring apparatus corresponding to a surveillance area.

The processor 420 is configured to acquire a real-time video from the video acquiring apparatus corresponding to the identifier, acquire real-time video superimposition information according to the identifier, where the real-time video superimposition information includes a superimposition position, real-time presentation information of an agent corresponding to the superimposition position, and agent management information corresponding to the superimposition position, and superimpose the real-time presentation information on the real-time video according to the superimposition position and superimpose the agent management information in a form of an operation menu on the real-time video according to the superimposition position in order to generate an interactive video.

The transmitter 430 is configured to send the interactive video to the client such that a user controls a call of the agent or sets a status of the agent using the operation menu in the interactive video displayed by the client.

The real-time presentation information includes agent identity information and agent real-time status information.

The processor 420 is further configured to acquire configuration information of the video acquiring apparatus according to the identifier, and perform configuration on the video acquiring apparatus according to the configuration information.

The configuration information includes a horizontal angle, a vertical angle, and a scaling parameter that are of the video acquiring apparatus, and the scaling parameter is determined according to a size of the surveillance area and a quantity of agents.

The processor 420 is further configured to store the interactive video as a playback video, where the playback video carries the identifier.

The receiver 410 is further configured to receive a playback request sent by the client, where the playback request carries playback information, and the playback information includes the identifier and a playback time point.

The processor 420 is further configured to acquire a playback video corresponding to the playback information.

The transmitter 430 is further configured to send the playback video to the client.

The receiver 410 is further configured to receive a playback request sent by the client, where the playback request carries playback information, and the playback information includes the identifier and a playback time point.

The processor 420 is further configured to acquire a playback video from the video acquiring apparatus corresponding to the identifier according to the playback time point, acquire playback video superimposition information according to the playback information, where the playback video superimposition information includes a superimposition position, and playback presentation information of an agent corresponding to the superimposition position, and superimpose the playback presentation information on the playback video according to the superimposition position in order to generate an interactive playback video.

The transmitter 430 is further configured to send the interactive playback video to the client.

The playback presentation information includes agent identity information and agent playback status information.

The superimposition position is preset according to a fixed video scene corresponding to a video acquiring apparatus.

Using the surveillance server provided in Embodiment 4 of the present disclosure, the surveillance server superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the surveillance server, thereby ensuring authenticity of a surveillance result.

The following uses FIG. 11 as an example to describe in detail a surveillance system provided in Embodiment 5 of the present disclosure, and FIG. 11 is a schematic diagram of a structure of the surveillance system according to Embodiment 5 of the present disclosure. The surveillance system includes a configuration server 510, a video acquiring apparatus 520, a surveillance server 530, and a client 540.

The surveillance server 530 is configured to implement the video surveillance method provided in Embodiment 1 of the present disclosure.

The configuration server 510 is configured to store configuration information of the video acquiring apparatus 520, real-time video superimposition information, and playback video superimposition information. The real-time video superimposition information and the playback video information that are acquired by the surveillance server 530 are acquired from the configuration server 510.

Using the surveillance system provided in Embodiment 5 of the present disclosure, a surveillance server superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

The following uses FIG. 12 as an example to describe in detail a client provided in Embodiment 6 of the present disclosure, and FIG. 12 is a schematic diagram of a structure of the client according to Embodiment 6 of the present disclosure. The client is used to implement the video surveillance method shown in FIG. 4.

As shown in FIG. 12, the client includes an acquiring unit 610, a generating unit 620, and a displaying unit 630.

The acquiring unit 610 is configured to acquire, according to an identifier of a video acquiring apparatus corresponding to a surveillance area selected by a user, a real-time video from the video acquiring apparatus corresponding to the identifier.

The identifier of the video acquiring apparatus may be a serial number of the video acquiring apparatus, may be an ID allocated by the surveillance server to the video acquiring apparatus, or the like.

Each surveillance area corresponds to one video acquiring apparatus, for example, a video camera. The video acquiring apparatus may be disposed on a top or on a wall in the surveillance area. Before the video acquiring apparatus acquires a video, the video acquiring apparatus needs to be configured in order to ensure that the video acquiring apparatus acquires a same video scene each time, including a same position of an agent, a same size, a same angle, and the like.

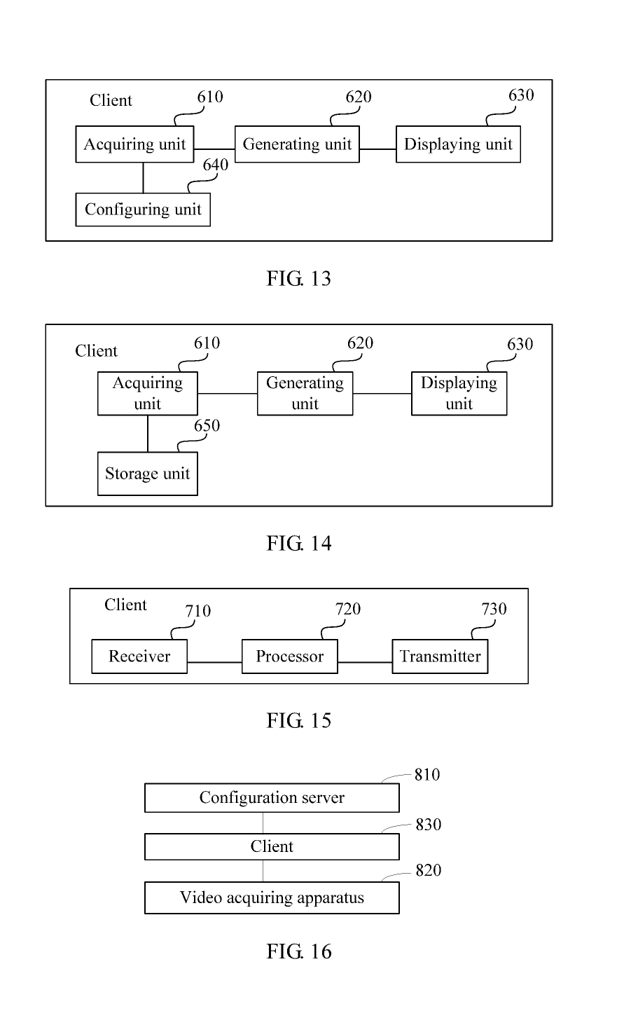

Therefore, as shown in FIG. 13, the client may further include a configuring unit 640. Before acquiring the real-time video from the video acquiring apparatus corresponding to the identifier, the acquiring unit 610 acquires configuration information of the video acquiring apparatus corresponding to the surveillance area from a configuration server according to the identifier. The configuring unit 640 performs configuration on the video acquiring apparatus according to the acquired configuration information.

The configuration information includes information such as a horizontal angle, a vertical angle, and a scaling parameter that are of the video acquiring apparatus. The configuration information is preset according to an actual situation of the surveillance area. For example, the scaling parameter is pre-adjusted according to a size of the surveillance area and a quantity of agents, and the horizontal angle and the vertical angle are adjusted according to an actual installation position of the video acquiring apparatus in order to determine a set of optimal configuration information.

The acquiring unit 610 is further configured to acquire real-time video superimposition information according to the identifier.

The acquiring unit 610 may acquire the real-time video superimposition information from the configuration server.

The real-time video superimposition information includes a superimposition position, real-time presentation information of an agent corresponding to the superimposition position, and agent management information corresponding to the superimposition position.

The superimposition position is a position that is in a real-time video and to which real-time presentation information and an operation menu are added. The superimposition position is arranged around an agent displayed in the video, and each superimposition position occupies one placeholder in the video. The superimposition position is preset according to a fixed video scene corresponding to a video acquiring apparatus. When the configuration information of the video acquiring apparatus is preset, the fixed video scene corresponding to the video acquiring apparatus can be determined, and then, a superimposition position corresponding to each agent is set according to the fixed video scene. A determined superimposition position in each surveillance area is pre-stored in the configuration server. When the fixed video scene changes, for example, when an agent in the surveillance area changes and the configuration information changes, the superimposition position needs to be reset.

The real-time presentation information of an agent corresponding to a superimposition position includes agent identity information (for example, an employee ID, a job title, and a name), and agent real-time status information (for example, status information of the agent: busy, idle, and on a call). The agent identity information is pre-stored in the configuration server, and the agent real-time status information may be acquired from a CTI server by the configuration server.

The agent management information corresponding to a superimposition position may include control information such as intercepting a call, breaking in on a call, and disconnecting a call, and setting information for setting a status of an agent to a specified state. The agent management information may be pre-configured and stored in the configuration server according to a requirement of a user.

The generating unit 620 is configured to superimpose the real-time presentation information on the acquired real-time video according to the superimposition position and superimpose the agent management information in a form of an operation menu on the acquired real-time video according to the superimposition position in order to generate an interactive video.

Because each surveillance area corresponds to a fixed video acquiring apparatus, and same configuration is performed on a video acquiring apparatus corresponding to a same surveillance area each time, a video scene acquired by the video acquiring apparatus corresponding to the same surveillance area each time is the same. Therefore, presentation information and an operation menu can be accurately added around each agent in an acquired real-time video according to video superimposition information.

Real-time presentation information of each agent and the acquired real-time video are superimposed according to a superimposition position corresponding to each agent, and agent management information in a form of an operation menu and the acquired real-time video are superimposed according to the superimposition position such that the user controls a call of each agent using the operation menu.

The displaying unit 630 is configured to display the interactive video.

The interactive video includes the real-time video acquired by the video acquiring apparatus, agent identity information and agent real-time status information of each agent, and an operation menu for each agent. Therefore, using the interactive video, the user can not only learn agent information and the real-time status information of each agent, but also learn an actual situation of each agent, for example, whether an agent operator is at a workstation, and an action and a facial expression of an agent operator. In addition, the user may use the operation menu to control a call of the agent and/or set a status of the agent.

Controlling on a call of the agent may include controlling such as intercepting a call, breaking in on a call to form a three-way call, and disconnecting a call.

Setting a status of the agent may include setting the agent to be idle, setting the agent to be busy, and the like.

Using the client provided in Embodiment 6 of the present disclosure, the client superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

Optionally, as shown in FIG. 14, the client provided in Embodiment 6 of the present disclosure may further include a storage unit 650. The client shown in FIG. 14 implements the method for video playback shown in FIG. 5.

The storage unit 650 is configured to store the interactive video as a playback video, where the playback video carries the identifier of the video acquiring apparatus that acquires the playback video.

The playback video is stored in an internal memory or an external memory of the client.

The acquiring unit 610 is further configured to acquire a playback video according to playback information selected by the user, where the playback information includes the identifier of the video acquiring apparatus and a playback time point.

Because all previous interactive videos are stored as playback videos in the internal memory or the external memory of the client, a playback video required by the user may be acquired from the internal memory or the external memory of the client according to a playback time point and an identifier of a video acquiring apparatus corresponding to a surveillance area that needs to be viewed by the user.

The displaying unit 630 is further configured to display the playback video.

The playback video includes an actual image of each agent in the surveillance area at the time point required by the user for viewing, and agent information and agent status information of each agent at the time, which can meet a requirement that the user views an earlier actual situation of the surveillance area.

Optionally, the client shown in FIG. 12 implements the method for video playback shown in FIG. 6.

The acquiring unit 610 is further configured to acquire a playback video from the video acquiring apparatus corresponding to the identifier according to playback information selected by the user, where the playback information includes the identifier of the video acquiring apparatus and a playback time point.

The video acquiring apparatus stores the previously acquired video as a playback video. Then, according to the playback information selected by the user, the acquiring unit 610 first determines, according to the identifier of the video acquiring apparatus, the video acquiring apparatus that acquires the playback video, and then may acquire a corresponding playback video from the determined video acquiring apparatus according to the playback time point.

The acquiring unit 610 is further configured to acquire playback video superimposition information according to the playback information, where the playback video superimposition information includes a superimposition position, and playback presentation information of an agent corresponding to the superimposition position.

The acquiring unit 610 may acquire the playback video superimposition information from the configuration server.

The playback presentation information includes agent identity information and agent playback status information. The configuration server stores previous agent real-time status information as agent playback status information in the configuration server. Then, the acquiring unit 610 may acquire, from the configuration server according to a playback time point and an identifier of a video acquiring apparatus corresponding to a surveillance area that needs to be viewed by the user, playback video superimposition information corresponding to a playback video required by the user.

The generating unit 620 is further configured to superimpose the playback presentation information on the playback video according to the superimposition position in order to generate an interactive playback video.

The currently used video is a playback video, adding an operation menu to the playback video is of little significance, and the user needs to be provided only with a real image of an agent at a time point required by the user, agent identity information, and agent status information at the time point required by the user. Therefore, an interactive playback video is generated only by superimposing playback presentation information on a playback video.

The displaying unit 630 is further configured to display the interactive playback video.

The interactive playback video includes an actual image of each agent in the surveillance area at the time point required by the user for viewing, and agent identity information and agent status information of each agent at the time, which can meet a requirement that the user views an earlier actual situation of the surveillance area.

The following uses FIG. 15 as an example to describe in detail a client provided in Embodiment 7 of the present disclosure, and FIG. 15 is a schematic diagram of a structure of the client according to Embodiment 7 of the present disclosure. The client is used to implement the video surveillance method in Embodiment 2 of the present disclosure. As shown in FIG. 15, the client includes a receiver 710, a processor 720, and a transmitter 730.

The processor 720 is configured to acquire, according to an identifier of a video acquiring apparatus corresponding to a surveillance area selected by a user, a real-time video from the video acquiring apparatus corresponding to the identifier, acquire real-time video superimposition information according to the identifier, where the real-time video superimposition information includes a superimposition position, real-time presentation information of an agent corresponding to the superimposition position, and agent management information corresponding to the superimposition position, superimpose the real-time presentation information on the real-time video according to the superimposition position and superimpose the agent management information in a form of an operation menu on the real-time video according to the superimposition position in order to generate an interactive video, and display the interactive video such that the user uses the operation menu in the interactive video to control a call of the agent or set a status of the agent.

The real-time presentation information includes agent identity information and agent real-time status information.

The processor 720 is further configured to, before acquiring, according to an identifier of a video acquiring apparatus corresponding to a surveillance area selected by a user, a real-time video from the video acquiring apparatus corresponding to the identifier, acquire configuration information of the video acquiring apparatus according to the identifier of the video acquiring apparatus corresponding to the surveillance area selected by the user, and perform configuration on the video acquiring apparatus according to the configuration information.

The configuration information includes a horizontal angle, a vertical angle, and a scaling parameter that are of the video acquiring apparatus, and the scaling parameter is determined according to a size of the surveillance area and a quantity of agents.

The processor 720 is further configured to, after displaying the interactive video, store the interactive video as a playback video, where the playback video carries the identifier, acquire a playback video according to playback information selected by the user, where the playback information includes the identifier and a playback time point, and display the playback video.

The processor 720 is further configured to, after displaying the interactive video, acquire a playback video from the video acquiring apparatus corresponding to the identifier according to playback information selected by the user, where the playback information includes the identifier and a playback time point, acquire playback video superimposition information according to the playback information, where the playback video superimposition information includes a superimposition position, and playback presentation information of an agent corresponding to the superimposition position, superimpose the playback presentation information and the playback video according to the superimposition position in order to generate an interactive playback video, and display the interactive playback video.

The playback presentation information includes agent identity information and agent playback status information.

The superimposition position is preset according to a fixed video scene corresponding to a video acquiring apparatus.

Using the client provided in Embodiment 7 of the present disclosure, the client superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

The following uses FIG. 16 as an example to describe in detail a surveillance system provided in Embodiment 8 of the present disclosure, and FIG. 16 is a schematic diagram of a structure of the surveillance system according to Embodiment 8 of the present disclosure. The surveillance system includes a configuration server 810, a video acquiring apparatus 820, and a client 830.

The client 830 is configured to implement the video surveillance method provided in Embodiment 2 of the present disclosure.

The configuration server 810 is configured to store configuration information of the video acquiring apparatus 820, real-time video superimposition information, and playback video information. The real-time video superimposition information and the playback video information that are acquired by the client 830 are acquired from the configuration server 810.

Using the surveillance system provided in Embodiment 8 of the present disclosure, a client superimposes real-time presentation information on an acquired real-time video according to a superimposition position and superimposes agent management information in a form of an operation menu on the acquired real-time video according to the superimposition position in order to generate an interactive video. The interactive video includes real-time presentation information and an actual image that are of each agent. Therefore, a user can learn an actual image of an agent using the video surveillance method, thereby ensuring authenticity of a surveillance result.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a compact disc-read-only memory (CD-ROM), or any other form of storage medium known in the art.

In the foregoing specific implementation manners, the objective, technical solutions, and benefits of the present disclosure are further described in detail. It should be understood that the foregoing descriptions are merely specific implementation manners of the present disclosure, but are not intended to limit the protection scope of the present disclosure. Any modification, equivalent replacement, or improvement made without departing from the spirit and principle of the present disclosure should fall within the protection scope of the present disclosure.

What is claimed is:

1. A video surveillance method, comprising:
receiving a surveillance request sent by a client, wherein the surveillance request carries an identifier of a video acquiring apparatus corresponding to a surveillance area;
acquiring a real-time video from the video acquiring apparatus corresponding to the identifier;
acquiring real-time video superimposition information according to the identifier, wherein the real-time video superimposition information comprises a superimposition position, real-time presentation information of an agent corresponding to the superimposition position, and agent management information corresponding to the superimposition position;
superimposing the real-time presentation information on the real-time video according to the superimposition position in order to generate an interactive video;
superimposing the agent management information in a form of an operation menu on the real-time video according to the superimposition position in order to generate an interactive video; and
sending the interactive video to the client such that a user controls a call of the agent or sets a status of the agent using the operation menu in the interactive video displayed by the client.

2. The method according to claim 1, wherein the real-time presentation information comprises agent identity information and agent real-time status information.

3. The method according to claim 1, wherein before acquiring the real-time video from the video acquiring apparatus corresponding to the identifier, the method further comprises:
acquiring configuration information of the video acquiring apparatus according to the identifier; and
performing configuration on the video acquiring apparatus according to the configuration information,
wherein the configuration information comprises a horizontal angle, a vertical angle, and a scaling parameter that are of the video acquiring apparatus, and wherein the scaling parameter is determined according to a size of the surveillance area and a quantity of agents.

4. The method according to claim 1, wherein after sending the interactive video to the client, the method further comprises:
storing the interactive video as a playback video, wherein the playback video carries the identifier;
receiving a playback request sent by the client, wherein the playback request carries playback information, and wherein the playback information comprises the identifier and a playback time point;
acquiring the playback video corresponding to the playback information; and
sending the playback video to the client.

5. The method according to claim 1, wherein after sending the interactive video to the client, the method further comprises:
receiving a playback request sent by the client, wherein the playback request carries playback information, and wherein the playback information comprises the identifier and a playback time point;
acquiring a playback video from the video acquiring apparatus corresponding to the identifier according to the playback time point;
acquiring playback video superimposition information according to the playback information, wherein the playback video superimposition information comprises a superimposition position, and playback presentation information of an agent corresponding to the superimposition position;
superimposing the playback presentation information on the playback video according to the superimposition position in order to generate an interactive playback video; and
sending the interactive playback video to the client.

6. A video surveillance method, comprising:
acquiring, according to an identifier of a video acquiring apparatus corresponding to a surveillance area selected by a user, a real-time video from the video acquiring apparatus corresponding to the identifier;
acquiring real-time video superimposition information according to the identifier, wherein the real-time video superimposition information comprises a superimposition position, real-time presentation information of an agent corresponding to the superimposition position, and agent management information corresponding to the superimposition position;
superimposing the real-time presentation information on the real-time video according to the superimposition position in order to generate an interactive video;
superimposing the agent management information in a form of an operation menu on the real-time video according to the superimposition position in order to generate an interactive video; and
displaying the interactive video such that the user uses the operation menu in the interactive video to control a call of the agent or set a status of the agent.

7. The method according to claim 6, wherein the real-time presentation information comprises agent identity information and agent real-time status information.

8. The method according to claim 6, wherein before acquiring, according to the identifier of the video acquiring apparatus corresponding to the surveillance area selected by the user, the real-time video from the video acquiring apparatus corresponding to the identifier, the method further comprises:
acquiring configuration information of the video acquiring apparatus according to the identifier of the video acquiring apparatus corresponding to the surveillance area selected by the user; and
performing configuration on the video acquiring apparatus according to the configuration information, wherein the configuration information comprises a horizontal angle, a vertical angle, and a scaling parameter that are of the video acquiring apparatus, and wherein the scaling parameter is determined according to a size of the surveillance area and a quantity of agents.

9. The method according to claim 6, wherein after displaying the interactive video, the method further comprises:
storing the interactive video as a playback video, wherein the playback video carries the identifier;
acquiring the playback video according to playback information selected by the user, wherein the playback information comprises the identifier and a playback time point; and
displaying the playback video.

10. The method according to claim 6, wherein after displaying the interactive video, the method further comprises:
acquiring a playback video from the video acquiring apparatus corresponding to the identifier according to playback information selected by the user, wherein the playback information comprises the identifier and a playback time point;
acquiring playback video superimposition information according to the playback information, wherein the playback video superimposition information comprises a superimposition position, and playback presentation information of an agent corresponding to the superimposition position;
superimposing the playback presentation information on the playback video according to the superimposition position in order to generate an interactive playback video; and
displaying the interactive playback video.

11. A surveillance server, comprising:
a receiver;
a processor coupled to the receiver; and
a transmitter coupled to the processor,
wherein the receiver is configured to receive a surveillance request sent by a client, wherein the surveillance request carries an identifier of a video acquiring apparatus corresponding to a surveillance area,
wherein the processor, is configured to:
acquire a real-time video from the video acquiring apparatus corresponding to the identifier;
acquire real-time video superimposition information according to the identifier, wherein the real-time video superimposition information comprises a superimposition position, real-time presentation information of an agent corresponding to the superimposition position, and agent management information corresponding to the superimposition position;
superimpose the real-time presentation information on the real-time video according to the superimposition position in order to generate an interactive video; and
superimpose the agent management information in a form of an operation menu on the real-time video according to the superimposition position in order to generate an interactive video, and
wherein the transmitter is configured to send the interactive video to the client such that a user controls a call of the agent or setting a status of the agent using the operation menu in the interactive video displayed by the client.

12. The surveillance server according to claim 11, wherein the real-time presentation information comprises agent identity information and agent real-time status information.

13. The surveillance server according to claim 11, wherein the processor is further configured to:
acquire configuration information of the video acquiring apparatus according to the identifier; and
perform configuration on the video acquiring apparatus according to the configuration information, wherein the configuration information comprises a horizontal angle, a vertical angle, and a scaling parameter that are of the video acquiring apparatus, and wherein the scaling parameter is determined according to a size of the surveillance area and a quantity of agents.

14. The surveillance server according to claim 11,
wherein the processor is further configured to store the interactive video as a playback video, wherein the playback video carries the identifier,
wherein the receiver is further configured to receive a playback request sent by the client, wherein the playback request carries playback information, wherein the playback information comprises the identifier and a playback time point,
wherein the processor is further configured to acquire the playback video corresponding to the playback information, and
wherein the transmitter is further configured to send the playback video to the client.

15. The surveillance server according to claim 11,
wherein the receiver is further configured to receive a playback request sent by the client, wherein the playback request carries playback information, wherein the playback information comprises the identifier and a playback time point,
wherein the processor is further configured to:
acquire a playback video from the video acquiring apparatus corresponding to the identifier according to the playback time point;
acquire playback video superimposition information according to the playback information, wherein the playback video superimposition information comprises a superimposition position, and playback presentation information of an agent corresponding to the superimposition position; and
superimpose the playback presentation information on the playback video according to the superimposition position in order to generate an interactive playback video, and
wherein the transmitter is further configured to send the interactive playback video to the client.

16. A client, comprising:
a processor; and
a non-transitory computer readable medium which contains computer-executable instructions and coupled to the processor,
wherein the processor is configured to execute the computer-executable instructions to perform the following operations:
acquire, according to an identifier of a video acquiring apparatus corresponding to a surveillance area selected by a user, a real-time video from the video acquiring apparatus corresponding to the identifier;
acquire real-time video superimposition information according to the identifier, wherein the real-time video superimposition information comprises a superimposition position, real-time presentation information of an agent corresponding to the superimposition position, and agent management information corresponding to the superimposition position;
superimpose the real-time presentation information on the real-time video according to the superimposition position in order to generate an interactive video;
superimpose the agent management information in a form of an operation menu on the real-time video according to the superimposition position in order to generate an interactive video; and
display the interactive video such that the user uses the operation menu in the interactive video to control a call of the agent or set a status of the agent.

17. The client according to claim 16, wherein the real-time presentation information comprises agent identity information and agent real-time status information.

18. The client according to claim 16, wherein the processor is further configured to execute the computer-executable instructions to perform the following operations:
acquire configuration information of the video acquiring apparatus according to the identifier of the video acquiring apparatus corresponding to the surveillance area selected by the user; and
perform configuration on the video acquiring apparatus according to the configuration information, wherein the configuration information comprises a horizontal angle, a vertical angle, and a scaling parameter that are of the video acquiring apparatus, and wherein the scaling parameter is determined according to a size of the surveillance area and a quantity of agents.

19. The client according to claim 16, wherein the processor is further configured to execute the computer-executable instructions to perform the following operations:
store the interactive video as a playback video, wherein the playback video carries the identifier;
acquire the playback video according to playback information selected by the user, wherein the playback information comprises the identifier and a playback time point; and
display the playback video.

20. The client according to claim 16, wherein the processor is further configured to execute the computer-executable instructions to perform the following operations:
acquire a playback video from the video acquiring apparatus corresponding to the identifier according to playback information selected by the user, wherein the playback information comprises the identifier and a playback time point;
acquire playback video superimposition information according to the playback information, wherein the playback video superimposition information comprises a superimposition position, and playback presentation information of an agent corresponding to the superimposition position;
superimpose the playback presentation information on the playback video according to the superimposition position in order to generate an interactive playback video; and
display the interactive playback video.
